(19) United States
(12) Patent Application Publication
(10) Pub. No.: US 2026/0151976 A1
(43) Pub. Date: Jun. 4, 2026

(54) LAND HEIGHT ADJUSTMENT BLOCK

(71) Applicant: Bridgestone Bandag, LLC, Nashville, TN (US)

(72) Inventors: Terry A. Westaway, Muscatine, IA (US); Shane L. Elam, Muscatine, IA (US)

(73) Assignee: Bridgestone Bandag, LLC, Nashville, TN (US)

(21) Appl. No.: 19/123,709

(22) PCT Filed: Oct. 19, 2023
(86) PCT No.: PCT/US2023/077285

§ 371 Date: Apr. 23, 2025

Related U.S. Application Data
(60) Provisional application No. 63/419,059, filed on Oct. 25, 2022.

(51) Int. Cl. B29D 30/06

(52) U.S. Cl. CPC B29D 30/0606; B29D 2030/0612

(57) ABSTRACT

A system for forming a tire tread includes a tire tread mold and a first sidewall height adjuster. The tire tread mold includes a base, a first sidewall, and a second sidewall. The first sidewall is contiguous with the base and includes a first sidewall joint structure. The second sidewall is contiguous with the base and positioned opposite of the first sidewall. The first sidewall height adjuster includes a first sidewall height adjuster joint structure. A portion of the first sidewall height adjuster joint structure is configured to receive a portion of the first sidewall joint structure such that the first sidewall and the first sidewall height adjuster is coupled or a portion of the first sidewall height adjuster joint structure is configured to be positioned within a portion of the first sidewall joint structure such that the first sidewall and the first sidewall height adjuster is coupled.

### CROSS REFERENCE TO RELATED PATENT APPLICATION(S)

The present application claims priority to U.S. Provisional Application No. 63/419,059 filed Oct. 25, 2022, the entire contents of which are incorporated herein by reference.

### FIELD

The present disclosure relates generally to the field of tire manufacturing. Specifically, the present disclosure relates to a common molding operation that includes vulcanizing a rubber composite material in a curing press.

### BACKGROUND

Curing presses include molds that enclose a rubber composite preform to provide pressure, and heat cures the preform into a useable article, for example, a strip or belt of tire tread. Such tire treads are typically used in tire retreading and other applications.

A typical curing press mold includes a mold plate that forms a cavity. One side of the cavity forms various depressions and ridges that correspond to the desired tread pattern of the tire tread that will emerge therefrom. A plate or platen is placed over the mold cavity after a tread preform has been loaded into the cavity. Pressure and heat are provided by the press to force the preform to assume the shape of the mold cavity and to cure the preform into vulcanized rubber.

### SUMMARY

One embodiment relates to a system for forming a tire tread including a tire tread mold and a first sidewall height adjuster. The tire tread mold comprising a base, a first sidewall, and a second sidewall. The first sidewall is contiguous with the base and includes a first sidewall joint structure. The second sidewall is contiguous with the base and positioned opposite of the first sidewall. The first sidewall height adjuster includes a first sidewall height adjuster joint structure. A portion of the first sidewall height adjuster joint structure is configured to receive a portion of the first sidewall joint structure such that the first sidewall and the first sidewall height adjuster is coupled or a portion of the first sidewall height adjuster joint structure is configured to be positioned within a portion of the first sidewall joint structure such that the first sidewall and the first sidewall height adjuster is coupled.

Another embodiment relates to a tire tread mold. The tire tread mold includes a base and a first sidewall. The first sidewall is contiguous with the base and includes a recessed portion and a first sidewall notch. The recessed portion is formed on the first sidewall and is configured to receive a pin of a first sidewall height adjuster such that a thickness of the first sidewall increases. The first sidewall notch extends from a position adjacent to the recessed portion toward the edge of the first sidewall. The first sidewall notch is configured to facilitate removal of the first sidewall height adjuster.

Another embodiment relates to a method of forming a system for forming a tire tread. The method includes providing a tire tread mold. The tire tread mold includes a base and a first sidewall. The first sidewall is contiguous with the base and includes a first sidewall joint structure. The first sidewall joint structure is formed on the first sidewall. The method further includes providing a first sidewall height adjuster. The first sidewall height adjuster includes a first sidewall height adjuster joint structure. The method includes aligning a portion of the first sidewall height adjuster joint structure to a portion of the first sidewall joint structure and pressing the first sidewall height adjuster toward the first sidewall such that first sidewall height adjuster joint structure couples to the first sidewall joint structure.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a system for forming a tire tread,

FIG. 2 is a top view of the system of FIG. 1,

FIG. 3 is a perspective view of a sidewall height adjuster,

FIG. 4 is a side view of a system for forming a tire tread, according to another embodiment,

FIG. 5 is a method for assembling a system for forming a tire tread, and

FIG. 6 is a method for decoupling the system for forming a tire tread.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

As used herein, the term “cure” and “cured” refers to the process of hardening raw material and/or the hardened material itself.

As used herein, the term “precured” refers to a material that is cured. Conversely, “uncured” refers to materials that are in their raw form and have not been cured. For example, curing an uncured material results in a cured or precured material.

As used herein, the term “tire tread” refers to a portion of rubber with patterns formed (e.g., cut, molded, etc.) within to increase the grip strength between the tire tread and the ground.

As used herein, the term “precured tire tread” refers to a tire tread that is separate from a tire casing. The precured tire tread has been cured and may take the form of a strip, ellipse, oval, circle, ring, or the like.

In order to form a tire, a precured tire tread is first manufactured. The precured tire tread is a formed of uncured rubber that is cured in a tire tread mold to form. The mold defines the shape and dimensions (e.g., length, width, thickness, etc.) of the precured tire tread and any features (e.g., channels, grooves, sipes, etc.) of the precured tire tread. The precured tire tread may be a blank (e.g., slick) without any features.

In order to form multiple precured tire treads with varying dimensions, multiple tire tread molds may be necessary. This process may require manufacturing multiple tire tread molds with various dimension, which may increase manufacturing cost and lead to material waste. Further, manufacturing multiple tire tread molds to achieve desired dimensions of the precured tire tread may be time consuming and labor intensive as an operator has to form all the portions of the mold and assemble the mold.

The exemplary non-limiting embodiments of the present disclosure provides a system for forming a tire tread. There are certain benefits to the system for forming a tire tread, as described herein. For example, the system reduces manufacturing costs, facilitates adjustment of the weight of the precured tire tread, and increases efficiency in the manufacturing process by quickly modifying dimensions of a standard tire tread mold to yield various tire treads, each tire tread having different dimensions.

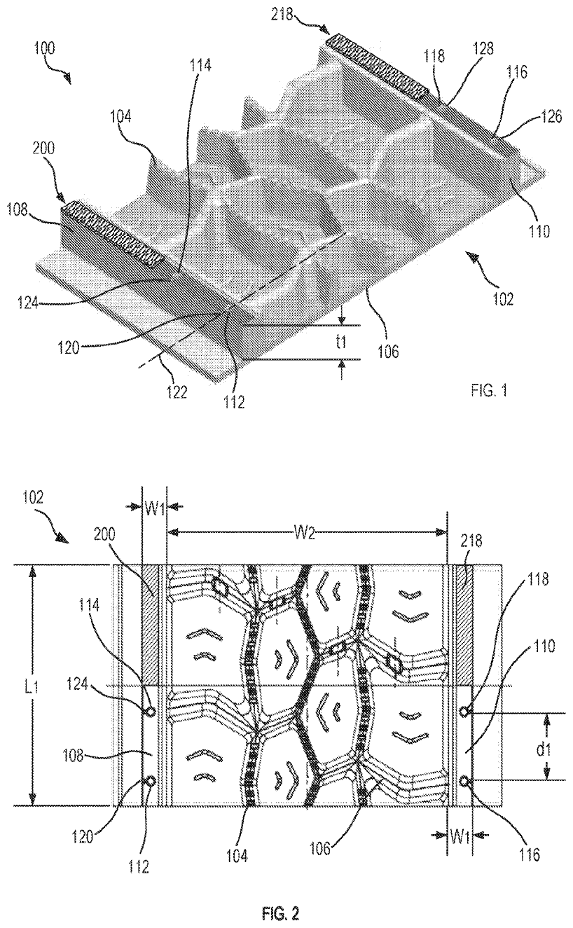

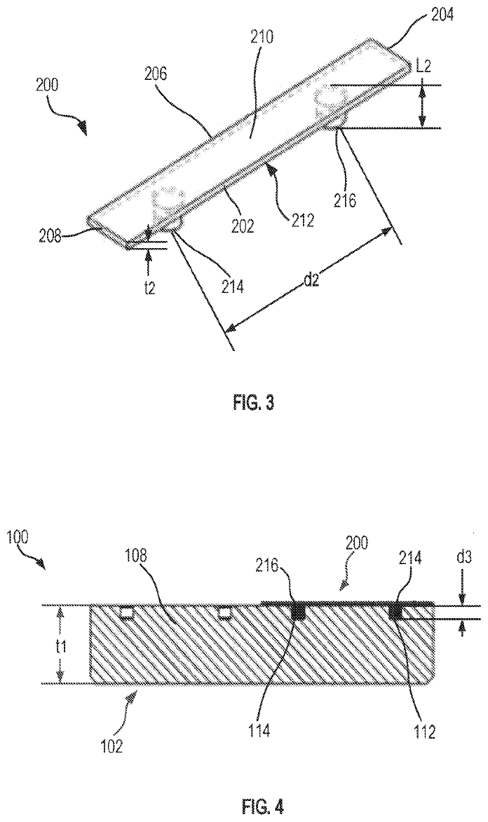

Referring to FIG. 1, a perspective view of a system 100 for forming a tire tread element is shown. The system includes a tire tread mold 102, as shown in FIG. 2. The tire tread mold 102 includes a tread pattern 104, a base 106, a first sidewall 108 (e.g., base gauge, etc.), and a second sidewall 110 (base gauge, etc.). The tread pattern 104 is a positive (e.g., extruded surface) that defines the features (e.g., grooves, channels, sipes, etc.) of the tire tread. The tread pattern 104 is coupled to the base 106 and interposed between the first sidewall 108 and the second sidewall 110. The tread pattern 104 may be integrally formed with the base 106. As utilized herein, two or more elements are “integrally formed” with each other when the two or more elements are formed and joined together to create a single-piece or unitary construction that cannot be disassembled without at least partial destruction of the overall component. Such joining may occur as part of a single manufacturing process. The first sidewall 108 and the second sidewall 110 are contiguous with the base 106. The first sidewall 108 is contiguous with a first side of the base 106 and the second sidewall 110 is contiguous with a second side of the base 106 such that the second sidewall 110 is opposite of the first sidewall 108. The first sidewall 108 and the second sidewall 110 may be coupled (e.g., attached, fixed, welded, fastened, riveted, adhered, bonded, pinned, etc.) to the base. In some embodiments, the first sidewall 108 and the second sidewall 110 are fixedly coupled to the base 106. The first sidewall 108 and the second sidewall 110 may be integrally formed to the base 106.

The first sidewall 108 and the second sidewall 110 extend away from the base 106 past the tread pattern 104 to provide a surface for uncured rubber to contact during the molding process. The first sidewall 108 and the second sidewall 110 may have thickness, t₁, approximately in a range of 0.5 inches (in.) to 2 in. (0.5 in., 0.75 in., 1.0 in., 1.25 in., 1.5 in., 1.75 in., 2.0 in., etc.). The first sidewall 108 and the second sidewall 110 may have a length, L₁, approximately in a range of 350 in. to 450 in. (e.g., 350 in., 360 in., 370 in., 380 in., 390 in., 400 in., 410 in., 420 in., 430 in., 440 in., 450 in., etc.). The first sidewall 108 and the second sidewall 110 may have a predetermined width, W₁. The first sidewall 108 and the second sidewall 110 may have width, W₁, approximately in a range of 0.50 in.-2.00 in. (e.g., 0.50 in, 0.75 in., 1.00 in., 1.25 in., 1.50 in., 1.75 in, 2.00 in., etc.).

Consequently, the base 106, the first sidewall 108, and the second sidewall 110 constrain the uncured rubber from spreading beyond an intended tire tread shape. The first sidewall 108 and the second sidewall 110 may be separated by a width, W₂, approximately in a range of 6 in. to 14 in., inclusive (e.g., about 6 in., about 7 in., about 8 in., about 9 in., about 10 in., about 11 in., about 12 in., about 13 in., about 14 in., etc.).

The first sidewall 108 includes a first sidewall joint structure 112 (e.g., recess portion, pin, aperture, protrusion, peg, etc.) The first sidewall joint structure 112 is formed on a top side of the first sidewall 108. The first sidewall joint structure 112 may be an aperture. The first sidewall joint structure 112 may be a protrusion extending from the top side of the first sidewall 108. The protrusion may be press fitted into the first sidewall 108 using a press machine (e.g., hydraulic press, etc.). In some embodiments, the first sidewall 108 may include a first sidewall second joint structure 114. The first sidewall second joint structure 114 is similar to the first sidewall joint structure 112. The first sidewall second joint structure 114 is positioned on the first sidewall 108 at a predetermined distance from the first sidewall joint structure 112. In some embodiments, the first sidewall second joint structure is positioned on the first sidewall 108 at a distance from the first sidewall joint structure 112 approximately in a range of 0.40 in.-2.0 in. (e.g., 0.40 in., 0.50 in., 0.60 in., 0.70 in., 0.80 in. 0.90 in., 1.00 in., 1.10 in., 1.20 in., 1.30 in., 1.40 in. 1.50 in., 1.60 in., 1.70 in., 1.80 in., 1.90 in., 2.00 in., etc.).

The second sidewall 110 includes a second sidewall joint structure 116 (e.g., recess portion, pin, aperture, protrusion, peg, etc.). The second sidewall joint structure 116 is formed on a top side of the second sidewall 110. The second sidewall joint structure 116 may be an aperture. The second sidewall joint structure 116 may be a protrusion extending from the top side of the second sidewall 110. In some embodiments, the second sidewall 110 may include a second sidewall second joint structure 118. The second sidewall second joint structure 118 is similar to the second sidewall joint structure 116. The second sidewall second joint structure 118 is positioned on the second sidewall 110 at a predetermined distance from the second sidewall joint structure 116. In some embodiments, the second sidewall joint structure 118 is at a distance, d₁, approximately in a range of 0.25 in., to 1.0 in. (e.g., 0.25 in., 0.50 in., 0.75 in., 1.0 in., etc.) from the second sidewall joint structure 116. In some embodiments, the first sidewall 108 and the second sidewall 110 include a plurality of sidewall joint structures which are positioned on the top side of the first sidewall 108 and the second sidewall 110 along the entire length of the first sidewall 108 and second sidewall 110. In some embodiments, each of the joint structures are positioned approximately in a range of 20% to 40% (e.g., 20%, 25%, 30%, 35%, 40%, etc.) of the segment length from opposing ends. Each of the joint structures are positioned at a distance, d₁, from another joint structure at a predetermined distance. In some embodiments, each of the joint structures are positioned at a distance, di, from another joint structure approximately in a range of 0.25 in., to 1.0 in. (e.g., 0.25 in., 0.50 in., 0.75 in., 1.0 in., etc.).

In some embodiments, the first sidewall 108 includes a first sidewall notch 120. The first sidewall notch 120 is positioned on the first sidewall 108 at a position adjacent to the first sidewall joint structure 112 and extends toward the edge of the top side of the first sidewall 108. The first sidewall notch 120 (e.g., gap, etc.) is formed by removing a portion of the first sidewall 108 such that a tool may be positioned within the first sidewall notch 120. The first sidewall notch 120 may extend from the first sidewall joint structure 112 through the edge of the first sidewall 108 such that a channel is formed from the edge of the first sidewall 108 to the first sidewall joint structure 112. The first sidewall notch 120 is configured to receive a tool and facilitate removal of a first sidewall height adjuster, as described herein. In some embodiments, the first sidewall notch 120 is centered on a notch axis 122. The first sidewall joint structure 112 may be centered on the notch axis 122 such that the first sidewall notch 120 and the first sidewall joint structure 112 are aligned. Consequently, deformation (e.g., warping, chipping, denting, fracturing, etc.) of the first sidewall height adjuster may be reduced when the tool is utilized to remove the first sidewall height adjuster, as described herein.

The first sidewall 108 may include a first sidewall second notch 124. The first sidewall second notch 124 is positioned adjacent to the first sidewall second joint structure 114. The first sidewall second notch 124 is substantially similar to the first sidewall notch 120 and therefore not further described in detail. In some embodiments, the second sidewall 110 may include a second sidewall notch 126 and a second sidewall second notch 128. The second sidewall notch 126 and the second sidewall second notch 128 are substantially similar to the first sidewall notch 120 and are therefore not further described in detail.

In some embodiments, the first sidewall 108 and the second sidewall 110 include a plurality of notches which are positioned adjacent to each of the plurality of joint structures along the length of the first sidewall 108 and the second sidewall 110. Each of the plurality of notches may be aligned to the respective joint structure, to which they are adjacent.

Referring to FIGS. 1-4, the system 100 includes a first sidewall height adjuster 200. The first sidewall height adjuster 200 is configured to couple to the first sidewall 108 and increase the thickness, t₁, of the first sidewall 108. That is, the collective thickness of the first sidewall 108 is increased owing to the coupling of the first sidewall height adjuster 200 thereto. In some embodiments, the first sidewall height adjuster 200 is configured to couple to the first sidewall 108 such that no gaps (e.g., space, crevice, etc.) exist between the first sidewall height adjuster 200 and the first sidewall 108. The first sidewall height adjuster may be formed from a metal or a metal alloy (e.g., aluminum, nickel, P2 steel, P3 steel, P4 steel, P5 steel, P6 steel, P20 steel, P21 steel, etc.).

The weight of the sidewall may be an important design consideration when forming a tire tread mold. For example, in some embodiments, the greater the weight of the sidewall, the more the sidewall may sway in a direction toward or away from the tread pattern. Consequently, this may affect the tire tread formed within the tire tread mold. Moreover, in cases where an element is coupled to the sidewall, the overall weight of the sidewall and the element may not exceed a threshold. During the forming process, the assembly of the tire tread mold and the element coupled to the sidewall may be placed in a pressurized chamber. In situations where the weight of the sidewall exceeds a threshold, the sidewall can sway, causing the element and the sidewall to partially decouple. This may cause a gap between the sidewall and the element in which uncured rubber may escape therein. This in turn may affect the final cured tread. It is appreciated that the weight of the sidewall and the element may be affected by various factors such as the materials used and/or the dimensions of the materials used.

As shown in FIG. 3, the first sidewall height adjuster 200 includes a first side 202, a second side 204, a third side 206, a fourth side 208, a top side 210, and a bottom side 212. The second side 204 is contiguous with the first side 202. The second side 204 may be perpendicular to the first side 202. The third side 206 is contiguous with the second side 204 and positioned opposite of the first side 202. The third side 206 may be parallel with the first side 202. The third side 206 may also be perpendicular with the second side 204. The fourth side 208 is contiguous with the first side 202 and the third side 206 and positioned opposite of the second side 204. The fourth side may be perpendicular to the first side 202 and the third side 206. The top side 210 is contiguous with the first side 202, the second side 204, the third side 206, and the fourth side 208. The top side 210 may be textured (e.g., rough, patterned, etc.). The top side 210 may be smooth. The bottom side 212 is positioned opposite of the top side 210 and is contiguous with the first side 202, the second side 204, the third side 206, and the fourth side 208. The bottom side 212 may be configured to be smooth such that no deformities (e.g., chips, bumps, divots, etc.) exist. In various embodiments, the first sidewall height adjuster may have various shapes (e.g., trapezoidal, serpentine, rectangular, etc.).

In some embodiments, the first sidewall height adjuster 200 may have a thickness, t₂, approximately in a range of 0.01 in. to 0.04 in. (e.g., 0.01 in., 0.02 in., 0.03 in., 0.04 in., etc.). In some embodiments, the first sidewall height adjuster may have a length approximately in a range of 350 in. to 450 in (e.g., 350 in., 360 in., 370 in., 380 in., 390 in., 400 in., 410 in., 420 in., 430 in., 440 in., 450 in., etc.). The first sidewall height adjuster 200 may have a width approximately in a predetermined range. In some embodiments, the first sidewall height adjuster 200 may have a width approximately in a range of 0.50 in.-12.0 in. (e.g., 0.50 in., 0.75 in., 1.0 in., 2.0 in., 3.0 in., 4.0 in., 5.0 in., 6.0 in., 7.0 in., 8.0 in., 9.0 in., 10.0 in., 11.0 in., 12.0 in., etc.). The dimensions of the first sidewall height adjuster 200 may be selected based on the material used and the density of the material(s). In particular, appropriate material(s) may be selected to prevent the first sidewall 108 and the first sidewall height adjuster 200 from swaying such that the first sidewall height adjuster 200 may become partially decoupled.

The first sidewall height adjuster 200 includes a first sidewall height adjuster joint structure 214 (e.g., recess portion, pin, aperture, protrusion, peg, etc.). The first sidewall height adjuster joint structure 214 is coupled to the bottom side 212 of the first sidewall height adjuster 200. In some embodiments, the first sidewall height adjuster joint structure 214 is integrally formed with the bottom side 212. The first sidewall height adjuster joint structure 214 may be a protrusion, which extends away from the bottom side 212. In some embodiments, the first sidewall height adjuster joint structure 214 is a recessed portion.

The first sidewall height adjuster 200 may include a first sidewall height adjuster second joint structure 216. The first sidewall height adjuster second joint structure 216 is substantially similar to the first sidewall height adjuster joint structure 214. The first sidewall height adjuster second joint structure 216 may be positioned at a distance, d₂, approximately in a predetermined range, from the first sidewall height adjuster joint structure 214. In some embodiments, the first sidewall height adjuster second joint structure 216 may be positioned at a distance, d₂, approximately in a range of 0.25 in. to 1.0 in. (e.g., 0.25 in., 0.50 in., 0.75 in., 1.0 in., etc.).

In operation, the first sidewall height adjuster 200 is positioned adjacent to the top of the first sidewall 108. The first sidewall height adjuster joint structure 214 is positioned such that the first sidewall height adjuster joint structure 214 interacts with the first sidewall joint structure 112. As shown in FIG. 4, in some embodiments, the first sidewall joint structure 112 is configured to receive a portion of the first sidewall height adjuster joint structure 214. Conversely, in some embodiments, the first sidewall height adjuster joint structure 214 is configured to receive a portion of the first sidewall joint structure 112. The first sidewall height adjuster 200 is forced toward the first sidewall 108 such that the first sidewall height adjuster joint structure 214 is coupled to the first sidewall joint structure 112, thereby coupling the first sidewall 108 with the first sidewall height adjuster 200. In this manner, the collective thickness of the first sidewall 108 is increased owing to the coupling of the first sidewall height adjuster 200 thereto. For example, when the first sidewall height adjuster 200 is coupled to the first sidewall 108, either by the first sidewall height adjuster joint structure 214 being a pin received by the first sidewall joint structure 112 or by the first sidewall height adjuster joint structure 214 being a recessed portion receiving the first sidewall joint structure 112, the effective thickness of the first sidewall 108 is increased. In particular, the effective thickness of the first sidewall 108 is increased relative to when the first sidewall height adjuster 200 is not coupled to the first sidewall 108 (i.e., the first sidewall height adjuster 200 being a pin and not being received by the recessed portion of the first sidewall 108). In some embodiments, an adhesive (glue, epoxy, adhesive tape, etc.) may be applied to a portion of the bottom side 212 of the first sidewall height adjuster 200. The adhesive may also be applied to a portion of the first sidewall 108 prior to coupling the first sidewall height adjuster 200.

In an exemplary embodiment, as seen in FIGS. 3-4 the first sidewall height adjuster joint structure 214 and the first sidewall height adjuster second joint structure 216 are protrusions, which extend from the bottom side 212. The first sidewall height adjuster joint structure 214 and the first sidewall height adjuster second joint structure 216 may be rectangular, cylindrical, trapezoidal, triangular, or a differing shape. The first sidewall height adjuster joint structure 214 and the first sidewall height adjuster second joint structure 216 may have a length, L₂, approximately in a predetermined range. In some embodiments, the first sidewall height adjuster joint structure 214 and the first sidewall height adjuster second joint structure 216 may have a length, L₂, approximately in a range of 0.25 in. to 1.0 in. (e.g., 0.25 in., 0.50 in., 0.75 in., 1.0 in., etc.). The first sidewall joint structure 112 and the first sidewall second joint structure 114 are recessed portions, which extend toward the base 106 and define an aperture on the first sidewall 108. The first sidewall joint structure 112 and the first sidewall second joint structure 114 have a depth, d₃, approximately in a predetermined range. In some embodiments, the first sidewall joint structure 112 and the first sidewall second joint structure 114 have a depth, d₃, approximately in a range of 0.25 in. to 1.0 in. (e.g., 0.25 in., 0.50 in., 0.75 in., 1.0 in., etc.). In some embodiments, the depth, d₃, is substantially similar to the length, L₂, of the first sidewall height adjuster joint structure 214 and the first sidewall height adjuster second joint structure 216. With such a construction, the first sidewall height adjuster joint structure 214 and the first sidewall height adjuster second joint structure 216 form an interference fit with the first sidewall joint structure 112 and the first sidewall second joint structure 114. The system 100 includes a second sidewall height adjuster 218. The second sidewall height adjuster 218 is substantially similar to the first sidewall height adjuster 200. The second sidewall height adjuster 218 is configured to couple to the second sidewall 110 in a similar manner as the first sidewall height adjuster 200 couples to the first sidewall 108.

In an exemplary embodiment, the first sidewall height adjuster joint structure 214 and the first sidewall height adjuster second joint structure 216 are apertures. The first sidewall height adjuster joint structure 214 and the first sidewall height adjuster second joint structure 216 may be apertures which are threaded. The first sidewall joint structure 112 and the first sidewall second joint structure 114 are recessed portions, which extend toward the base 106 and define an aperture on the first sidewall 108. The first sidewall joint structure 112 and the first sidewall second joint structure 114 may be threaded. With such a construction, a threaded fastener (e.g., screw, bolt, etc.) is positioned within the first sidewall height adjuster joint structure 214 and the first sidewall joint structure 112 and rotated so as to couple the first sidewall height adjuster 200 to the first sidewall 108. A second threaded fastener may be positioned within the first sidewall height adjuster second joint structure 216 and the first sidewall second joint structure 124 and rotated so as to couple the first sidewall height adjuster 200 to the first sidewall 108.

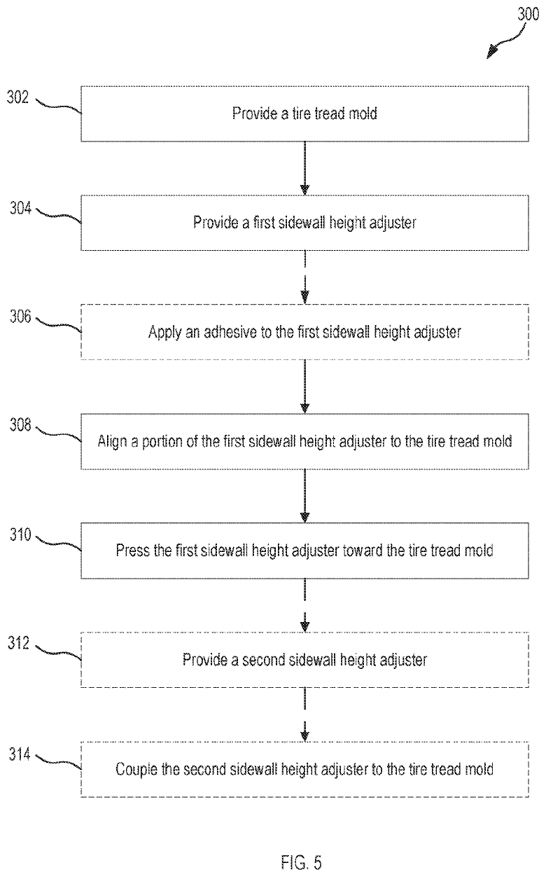

Referring to FIG. 5, a block diagram of a method 300 of assembling a system (e.g., system 100, etc.) for forming a tire tread. In step 302, a tire tread mold is provided. The tire tread mold includes a base and a first sidewall contiguous with the base. The tire tread mold may include a second sidewall contiguous with the base and positioned opposite of the first sidewall. The first sidewall includes a first sidewall joint structure. In some embodiments, the first sidewall includes a plurality of first sidewall joint structures. The first sidewall may include a notch. The notch is positioned on the first sidewall and may be adjacent to the first sidewall joint structure. In some embodiments, the first sidewall may include a plurality of notches where each notch is adjacent to at least one of the plurality of joint structures of the first sidewall.

In step 304, a first sidewall height adjuster is provided. The first sidewall height adjuster includes a first sidewall height adjuster joint structure. The first sidewall height adjuster joint structure may be a protrusion coupled to a portion of the first sidewall height adjuster. The first sidewall height adjuster may be manufactured from a block of metal or metal alloy (e.g., aluminum, nickel, P2 steel, P3 steel, P4 steel, PS steel, P6 steel, P20 steel, P21 steel, etc.). Specifically, manufacturing machinery (e.g., a CNC machine, lathe, mill, etc.) is operated to cut into the surface of the block of material until desired dimensions are achieved. For example, the block of material used to form the first sidewall height adjuster may be machined such that the thickness is approximately in a range of 0.01 in. to 0.04 in.

In step 306, an adhesive may be optionally applied. The adhesive may be applied to a portion of the first sidewall height adjuster. In some embodiments, the adhesive may be applied to a portion of the first sidewall. The adhesive is configured to cause adhesion between the first sidewall and the first sidewall height adjuster when the first sidewall height adjuster is coupled to the first sidewall, as described herein.

In step 308, a portion of the first sidewall height adjuster is aligned with the tire tread mold. Specifically, the first sidewall height adjuster aligns with the first sidewall such that the first sidewall joint structure and the first sidewall height adjuster joint structure are aligned. In some embodiments, the first sidewall height adjuster is aligned such that a portion of the first sidewall height adjuster joint structure is positioned within first sidewall joint structure. In yet another embodiment, the first sidewall joint structure is aligned such that a portion of the first sidewall joint structure is positioned within the first sidewall height adjuster joint structure. In some embodiments, the first sidewall height adjuster includes a plurality of joint structures.

In step 310, the first sidewall height adjuster is pressed toward the tire tread mold. By pressing the first sidewall height adjuster toward the tire tread mold, in some embodiments, the first sidewall height adjuster joint structure is entirely positioned within the first sidewall joint structure. In another embodiment, by pressing the first sidewall height adjuster toward the tire tread mold, the first sidewall joint structure is entirely positioned within the first sidewall height adjuster joint structure.

In step 312, a second sidewall height adjuster may optionally be provided. The second sidewall height adjuster is substantially similar to the first sidewall height adjuster. In step 314, the second sidewall height adjuster is optionally coupled to the tire tread mold. Specifically, the second sidewall height adjuster is coupled to the second sidewall of the tire tread mold in a similar manner as steps 306-310.

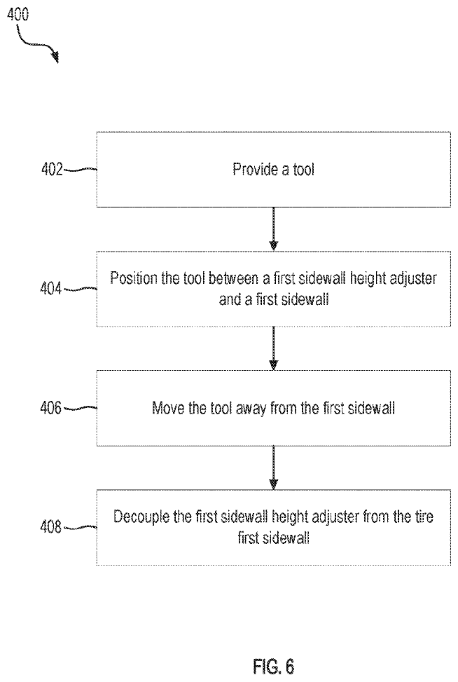

Referring to FIG. 6, a block diagram of a method 400 of decoupling the first sidewall height adjuster is shown. The method 400, as described herein, may also be utilized to decouple the second sidewall height adjuster from the second sidewall. In step 402, a tool is provided. The tool may be a flat tool (e.g., crowbar, flat head screwdriver, shim, etc.). The tool is configured to cause the first sidewall height adjuster to be decoupled from the first sidewall. In step 404, the tool is positioned between the first sidewall height adjuster and the first sidewall. The tool may be positioned within the notch of the first sidewall. The tool is positioned such that a portion of the tool is between the first sidewall height adjuster and the first sidewall. In step 406, the tool is moved away from the first sidewall toward the first sidewall height adjuster until the tool makes contact with the first sidewall height adjuster. In step 408, the first sidewall height adjuster is decoupled from the first sidewall. Specifically, once the tool makes contact with a portion of the first sidewall height adjuster, the tool facilitates movement of the first sidewall height adjuster away from the first sidewall. Consequently, the first sidewall height adjuster joint structure is decoupled from the first sidewall joint structure. Steps 404 through 408 may be repeated for each of a plurality of first sidewall height adjuster joint structures, which are coupled to at least one of a plurality of first sidewall joint structures. In this manner, the first sidewall height adjuster may be decoupled from the first sidewall.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims. Further, a reference to elements being “similar” or substantially like other elements indicates that various modifications are contemplated within the scope of the disclosure, and where one element is described as similar to another, a description of the former may be omitted for the sake of brevity.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

References herein to the relative order of elements (e.g., “first”, “second,” “third,” “fourth”) are merely used for the purpose of illustration and are not intended to be limiting.

Although the figures may show a specific order of method steps, the order of the steps may differ from what is depicted. In some embodiments, two or more steps may be performed concurrently or with partial concurrence. All such variations are within the scope of the disclosure. While various aspects and embodiments have been disclosed herein, other aspects and embodiments will be apparent to those skilled in the art. The various aspects and embodiments disclosed herein are for purposes of illustration and are not intended to be limiting, with the scope and spirit of the disclosure being indicated by the following claims.

1. A system for forming a tire tread comprising:
a tire tread mold including:
a base;
a first sidewall contiguous with the base, the first sidewall including a first sidewall joint structure; and
a second sidewall contiguous with the base and positioned opposite of the first sidewall; and
a first sidewall height adjuster including a first sidewall height adjuster joint structure,
wherein:
a portion of the first sidewall height adjuster joint structure is configured to receive a portion of the first sidewall joint structure such that the first sidewall and the first sidewall height adjuster are coupled, or
a portion of the first sidewall height adjuster joint structure is configured to be positioned within a portion of the first sidewall joint structure such that the first sidewall and the first sidewall height adjuster are coupled.

2. The system of claim 1, further comprising a second sidewall height adjuster including a second sidewall height adjuster joint structure and wherein the second sidewall includes a second sidewall joint structure.

3. The system of claim 2, wherein:
a portion of the second sidewall height adjuster joint structure is configured to receive a portion of the second sidewall joint structure such that the second sidewall and the second sidewall height adjuster are coupled, or
a portion of the second sidewall height adjuster joint structure is configured to be positioned within a portion of the second sidewall joint structure such that the second sidewall and the second sidewall height adjuster are coupled.

4. The system of claim 1, wherein the first sidewall height adjuster joint structure is a pin.

5. The system of claim 4, wherein the first sidewall joint structure is a recessed portion such that when the pin is coupled to the recessed portion, the first sidewall and the first sidewall height adjuster form an interference fit.

6. The system of claim 1, wherein the first sidewall joint structure is a protrusion extending from a top surface of the first sidewall.

7. The system of claim 1, wherein the first sidewall further includes a first sidewall second joint structure positioned on the first sidewall at a distance from the first sidewall joint structure.

8. The system of claim 2, wherein the second sidewall further includes a second sidewall second joint structure positioned on the second sidewall at a distance from the second sidewall joint structure.

9. A tire tread mold comprising:
a base; and
a first sidewall contiguous with the base, the first sidewall including:
a recessed portion formed on the first sidewall, the recessed portion configured to receive a pin of a first sidewall height adjuster, wherein when the first sidewall height adjuster is coupled to the first sidewall by the pin being received in the recessed portion, a thickness of the first sidewall is increased; and
a first sidewall notch extending from a position adjacent to the recessed portion toward an edge of the first sidewall, the first sidewall notch configured to facilitate removal of the first sidewall height adjuster.

10. The tire tread mold of claim 9, wherein the first sidewall notch and the recessed portion are aligned along an axis.

11. The tire tread mold of claim 9, wherein the pin of the first sidewall height adjuster forms an interference fit with the recessed portion.

12. The tire tread mold of claim 9, wherein the first sidewall includes:
a plurality of recessed portions along a length of the first sidewall configured to receive the first sidewall height adjuster; and
a plurality of first sidewall notches corresponding to the plurality of recessed portions, each first sidewall notch extending from a respective position adjacent to a corresponding recessed portion toward the edge of the first sidewall.

13. The tire tread mold of claim 9, further comprising a second sidewall contiguous with the base and positioned opposite of the first sidewall.

14. The tire tread mold of claim 13, further comprising a second recessed portion formed on the second sidewall, the second recessed portion configured to receive a pin of a second sidewall height adjuster such that a thickness of the second sidewall increases.

15. The tire tread mold of claim 14, further comprising a second sidewall notch extending from a position adjacent to the recessed portion toward an edge of the second sidewall, the second sidewall notch configured to facilitate removal of the second sidewall height adjuster.

16. The tire tread mold of claim 13, further comprising a tread pattern coupled to the base and interposed between the first sidewall and the second sidewall and configured to define features of a tire tread.

17. A method of assembling a system for forming a tire tread comprising:
providing a tire tread mold including:
a base; and
a first sidewall contiguous with the base, the first sidewall including a first sidewall joint structure formed on the first sidewall;
providing a first sidewall height adjuster, the first sidewall height adjuster including a first sidewall height adjuster joint structure;
aligning a portion of the first sidewall height adjuster joint structure to a portion of the first sidewall joint structure; and
pressing the first sidewall height adjuster toward the first sidewall such that the first sidewall height adjuster joint structure couples to the first sidewall joint structure.

18. The method of claim 17, wherein the first sidewall further includes a first sidewall notch, the first sidewall notch extending from a position adjacent the first sidewall joint structure toward an edge of the first sidewall.

19. The method of claim 18, further comprising:
positioning a tool within the first sidewall notch on the first sidewall;
moving the tool toward the first sidewall height adjuster; and
decoupling the first sidewall height adjuster from the first sidewall.

20. The method of claim 17, wherein the tire tread mold further includes a second sidewall contiguous with the base and positioned opposite the first sidewall, the second sidewall including a second sidewall joint structure formed on the second sidewall, the method further comprising:
providing a second sidewall height adjuster, the second sidewall height adjuster including a second sidewall height adjuster joint structure;
aligning a portion of the second sidewall height adjuster joint structure to a portion of the second sidewall joint structure; and
pressing the second sidewall height adjuster toward the second sidewall such that the second sidewall height adjuster joint structure couples to the second sidewall joint structure.
